(19) United States
(12) Patent Application Publication
(10) Pub. No.: US 2007/0096580 A1
(43) Pub. Date: May 3, 2007

(54) Stator of an electric machine

(76) Inventor: Karl-Hermann Ketteler, Markdorf (DE)

Correspondence Address: DAVIS & BUJOLD, P.L.L.C., 112 PLEASANT STREET, CONCORD, NH, 03301, US

(21) Appl. No.: 11/581,906

(22) Filed: Oct. 17, 2006

(30) Foreign Application Priority Data
Oct. 27, 2005 (DE) 102005051380.8

(51) Int. Cl. H02K 3/00; H02K 5/12

(52) U.S. Cl. 310/179; 310/254; 310/184

(57) ABSTRACT

ABSTRACT OF THE DISCLOSURE A stator (1) for an electric machine, in particular a three-phase current machine for motor vehicles, which consists of a winding support (2) having grooves (3) and teeth (4). Windings (5) are arranged in the grooves. Winding support (2) consists of a plurality of identical segments (6) which, after being wound, are shaped into a circular ring. The segments are then advantageously inserted into a cylindrical housing (9) and, with their windings (5), form the cylindrical stator (1).

### STATOR OF AN ELECTRIC MACHINE

This application claims priority from German Application Serial No. 10 2005 051 380.8 filed Oct. 27, 2005.

### FIELD OF THE INVENTION

The invention concerns a stator of an electric machine and a method for producing such a stator.

### BACKGROUND OF THE INVENTION

From DE 10 2004 001 842 A1 a stator with a winding support is known, which has a plurality of grooves and teeth. A several winding strands are inserted in the grooves. To enable the winding strands to be inserted, they are pre-wound in such manner that they can be moved over the teeth without problems.

From DE 103 61 670 A1, a stator with a winding support is known, in which several pre-wound winding strands are inserted in the initially flat winding support.

The winding support is then bent into a ring in order for a cylindrical stator with the windings.

To enable the pre-wound winding strands to be inserted into the grooves, they must fit over the teeth with a certain clearance. This results in winding head loops, which project in the axial direction far beyond the stator. This increases the amount of axial space needed for accommodating the stator. Furthermore, the winding strands overlap in the radial direction in the known designs. Accordingly, the radial space occupied by the stator is also disadvantageously increased.

The purpose of the present invention is to provide a stator which occupies little axis and radial space, and also to develop a method by which such a stator can be produced particularly simply and inexpensively.

### SUMMARY OF THE INVENTION

According to the invention, the stator consists of a winding support having teeth and grooves. Furthermore, windings are arranged in the grooves. The winding support consists of a plurality of identical segments each having at least two teeth, which are individually wound with the windings. The individual segments are attached to one another in such manner that, together with the windings, they form a cylindrical stator. Advantageously, the stator is arranged in a housing.

The windings of the individual segments are electrically connected to one another. Advantageously, the connections are arranged inside the grooves of the winding support. As a result, there is no crossing over of the windings in the winding head loops so the winding head loops can be smaller than in the known designs. The windings of individual segments can be connected in parallel or preferably in series.

The magnetic properties of the stator can be influenced by the number of turns in the individual windings. Accordingly, the number of turns of the individual windings can be made the same or different. Likewise, the winding direction on the individual windings of a segment can be the same or different.

The stator has segments with more than one tooth. An advantageous design is for the stator to have individual segments each with three teeth. The windings of the segments can be connected in series, in parallel or even mixed, i.e., partly in series and partly in parallel.

The segments associated with a phase can be arranged in star or delta form, i.e., in a ring, one after the other.

According to the invention, the individual segments are flat before winding. This means that, the rear side of the segments is flat and the teeth are advantageously orientated parallel to one another. Since the shape of all the segments is the same, the windings can be positioned on them mechanically in large numbers and particularly simply and inexpensively. After winding, the segments are bent into circular arcs with the teeth on the inside of the circular segments. This gives a further advantage. Since the deformation reduces the space within the grooves, the turns inside them are pressed closer together. This enables the grooves to be filled with turns in a way not possible with normal winding methods. A high groove filling ratio directly increases the power density of the machine and thus acts to increase its power. To obtain a stator, the desired number of segments are arranged in a ring and connected together, whereby a cylindrical winding support is produced. This winding support is advantageously fitted into a cylindrical housing to increase the stability of the stator.

Furthermore, the ready-shaped cylindrical stator can be stabilized even more by way of a cast-in mass.

### BRIEF DESCRIPTION OF THE DRAWINGS

The invention will now be described, by way of example, with reference to the accompanying drawings in which:

FIG. 1 is a structure of a stator;

FIG. 2 is a structure of a segment;

FIG. 3 is a segment after winding and shaping;

FIG. 4 is a schematic representation of the winding of a segment, and

FIGS. 5 to 7 are representation of the arrangement of the segments and windings.

### DETAILED DESCRIPTION OF THE INVENTION

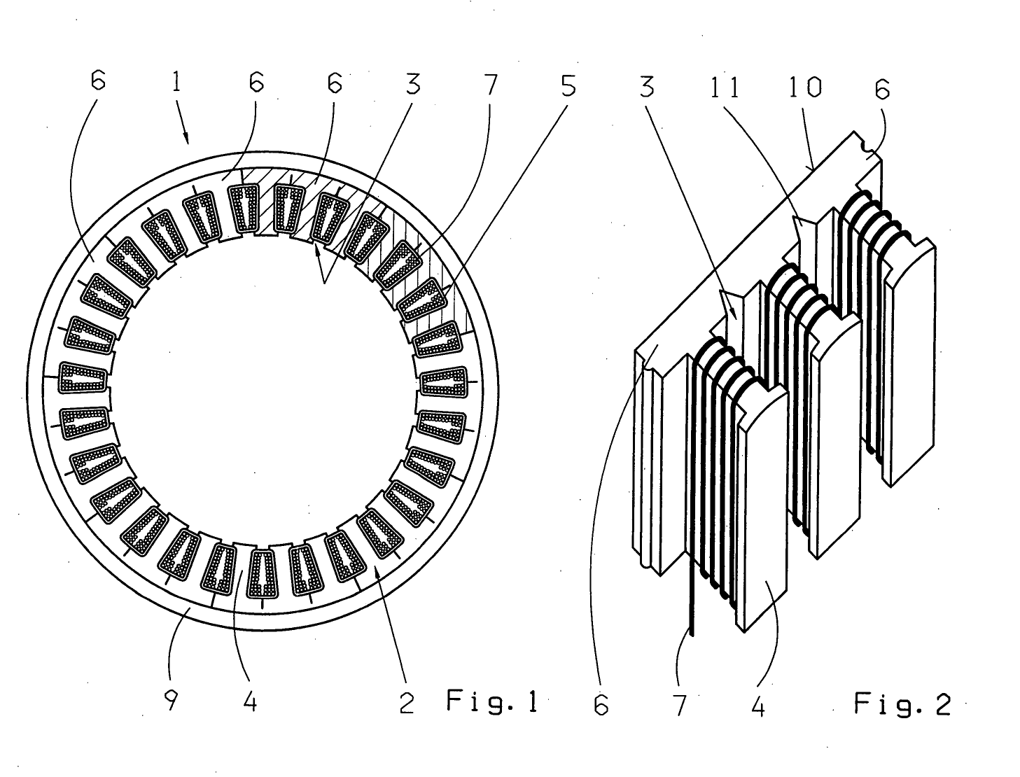

FIG. 1 shows a stator 1 according to the invention. A winding support 2 consists of nine identical segments 6. Each segment 6 has three teeth 4 and corresponding grooves 3 between the teeth 4. Windings 5 with their turns 7 can be seen in the grooves 3. For the sake of clearer representation only a small number of turns 7 are shown, which have not been pressed together by the shaping deformation. The stator 1 is of the type used for a three-phase current generator. For this, three segments 6 at a time are electrically connected in the manner of a star circuit. The segments 6 associated with the various phases are arranged directly adjacent to one another, so that in the circumferential direction every third segment 6 is associated with one phase of the stator 1. Around the segments 6 of the winding support 2 is fitted a housing 9 to increase the stability of the stator 1.

FIG. 2 shows the segment 6 before it has been deformed. In the Figure, a flat rear side 10 of the segment can be seen, the parallel teeth 4 and the turns 7 wound around the teeth 4. There are V-shaped recesses 11 at the bottom of the grooves, which facilitate the shaping of the segment 6.

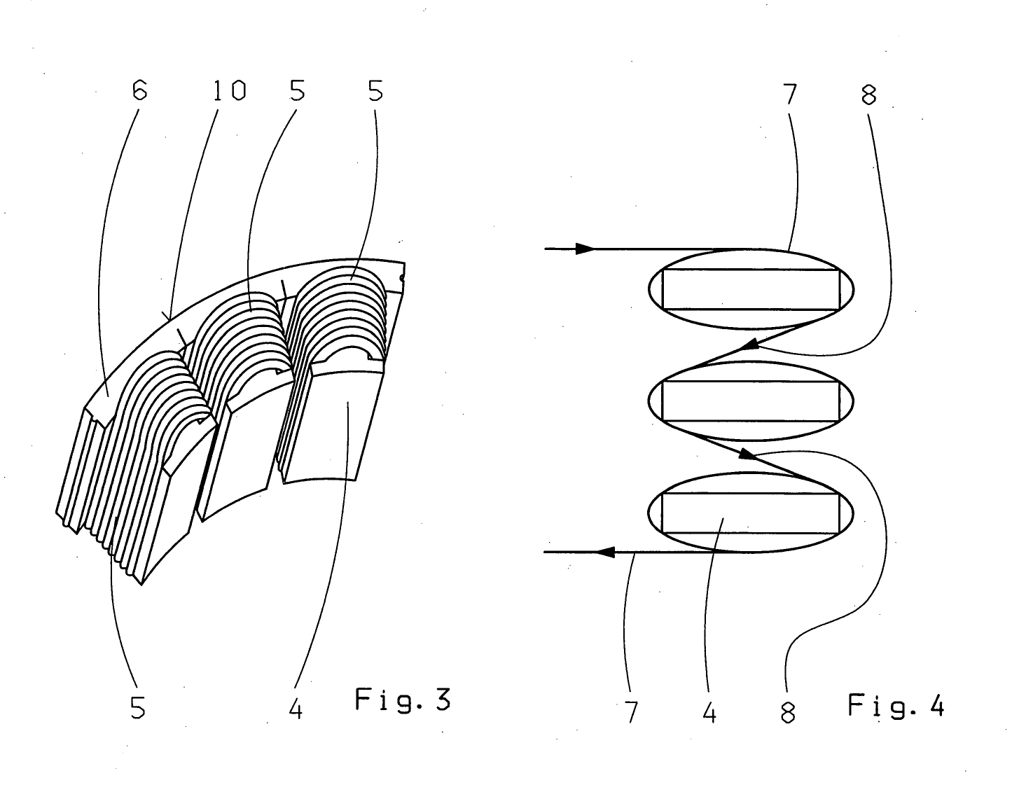

FIG. 3 shows the fully-wound segment 6 which has been shaped after winding. The windings 5 are wound round the teeth 4 and have been pressed together by the deformation of the segment 6. The rear side 10 of the segment 6 is shaped in a circular arc and the teeth 4 are on the radially inner side of the circular arc segment.

FIG. 4 shows the manner in which the turns 7 are wound round the teeth 4. It can be seen that the winding direction alternates between adjacent teeth 4. In addition, the sections of the turns 7 are shown, which constitute connections 8 by which the individual windings 5 are connected to one another. Advantageously, these connections 8 are arranged in the grooves 3.

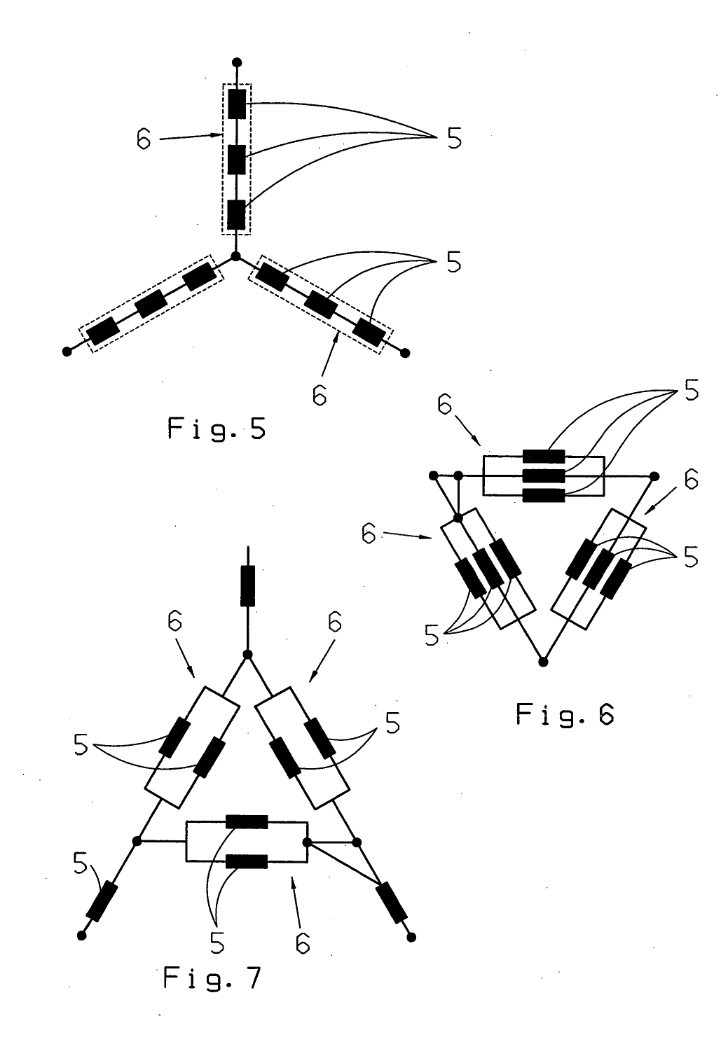

FIG. 5 shows thee segments, each with three windings, the individual windings 5 of the segment 6 being connected in series with one another. The segments 6 are again arranged in star connection.

FIG. 6 shows three segments, each with three windings, the individual windings 5 of the segment 6 being connected in parallel with one another. The segments are arranged in delta form.

FIG. 7 shows a mixed arrangement in which the windings 5 of the segment 6 are connected with one another partly in parallel and partly in series. The segments 6 are arranged partly in star and partly in delta connection.

### REFERENCE NUMERALS

1 stator
2 winding support
3 groove
4 tooth
5 winding
6 segment
7 turn
8 connection
9 housing
10 rear side of a segment
11 recess

1-10. (canceled)

11. A stator (1) for a three-phase current machine for a motor vehicle, the stator comprising a winding support (2) having grooves (3) and teeth (4) with windings (5) arranged in the grooves (3),
the winding support (2) comprising a plurality of identical segments (6), each of the identical segments (6) having a plurality of teeth (4) with turns (7) of the winding (5) wound around each tooth (4), and each of the identical segments (6) being attached to one another in a circle to form a cylindrical stator (1).

12. The stator according to claim 11, wherein the windings (5) of each of the identical segments (6) are electrically connected to one another, and the connections(8) are positioned inside the grooves (3).

13. The stator according to claim 11, wherein the windings (5) of each of the identical segments (6) are connected in series with one another.

14. The stator according to claim 11, wherein the windings (5) of each of the identical segments (6) have one of:
an identical number of turns (7), and
a different number of turns (7).

15. The stator according to claim 11, wherein a winding direction of the windings (5) of each of the identical segments (6) one of changes from tooth (4) to tooth (4) and is identical from tooth (4) to tooth (4).

16. The stator according to claim 11, wherein each of the identical segments (6) has more than one tooth (4) and the segments (6) associated with one phase are connected in one of
in series with one another, and
in parallel with one another.

17. The stator according to claim 11, wherein each of the identical segments (6) are arranged in one of:
a star connection,
a delta connection, and
partly in a star and partly in a delta connection.

18. A method for producing a stator for a three-phase current machine for a motor vehicle, the stator comprising a winding support (2) having grooves (3) and teeth (4) with windings (5) arranged in the grooves (3), the winding support (2) comprising a plurality of identical segments (6), each of the identical segments (6) having a plurality of teeth (4) with turns (7) of the winding (5) wound around each tooth (4), each of the identical segments (6) being attached to one another in a circle to form a cylindrical stator (1), the method comprising the steps of:
making the segments (6) flat with parallel teeth (4) before being wound;
individually winding each of the teeth (4);
deforming and connecting, after winding, the segments (6) to one another to form from a plurality of segments (6), and a cylindrical winding support (2) with the teeth(4) arranged on a radially inner side.

19. The method according to claim 18, further comprising the step of winding the teeth (4) with sufficient turns (7) to compress the windings (5) within the grooves (3) by deformation of the segments (6).

20. The method according to claim 18, further comprising the step of inserting the cylindrical winding support (2) into a cylindrical housing (9).
